(19) United States
(12) Patent Application Publication
(10) Pub. No.: US 2024/0211634 A1
(43) Pub. Date: Jun. 27, 2024

(54) METHOD FOR MANAGING IMAGE BASED ON DE-IDENTIFICATION, APPARATUS FOR THE SAME, COMPUTER PROGRAM FOR THE SAME, AND RECORDING MEDIUM STORING COMPUTER PROGRAM THEREOF

(71) Applicant: Fasoo Co., Ltd., Seoul (KR)

(72) Inventors: Chang Jin KOO, Seoul (KR); Woo Sung CHOI, Seoul (KR)

(21) Appl. No.: 18/486,636

(22) Filed: Oct. 13, 2023

(30) Foreign Application Priority Data
Dec. 27, 2022 (KR) 10-2022-0185497
Jul. 6, 2023 (KR) 10-2023-0088008

(51) Int. Cl. G06F 21/62

(52) U.S. Cl. CPC G06F 21/6254

(57) ABSTRACT

A method for managing an image according to an aspect of the present disclosure may include determining a de-identification target among all regions in an image; performing de-identification processing for the de-identification target; and storing an image file including both data corresponding to an original image of the de-identification target and data corresponding to a de-identified image.

### CROSS-REFERENCE TO RELATED APPLICATIONS

The present application claims priority to Korean Patent Application No. 10-2022-0185497, filed on Dec. 27, 2022, and Korean Patent Application No. 10-2023-0088008 filed on Jul. 6, 2023, which are hereby incorporated by reference in its entirety.

### TECHNICAL FIELD

The present disclosure relates to a method, a device, a computer program and a recording medium for managing an image based on de-identification and specifically, it relates to an image management method, device, computer program and recording medium provided only to a user who gains permission for the protection of personally identifiable information.

### BACKGROUND ART

The present disclosure relates to a method for analysis on de-identification interim result data, an apparatus for the same, a computer program for the same, and a recording medium storing computer program thereof, and more particularly to a method configured to provide an analysis on interim result data occurring during an de-identification procedure, an apparatus for the same, a computer program for the same, and a recording medium storing computer program thereof

As utilization of data increases, a new requirement for constructing and utilizing big data that various forms of data has been accumulated. Personally identifiable information included in an image, one of unstructured data, is also one of personal information that de-identification processing is required. But, a method for storing both an original image and an image which is subject to personal information de-identification processing, providing a de-identified image to a general user and providing original data only when permission is obtained causes inefficiency in data redundancy and hinders an effective personal information protection method.

Accordingly, a new method for managing an image based on one image including a de-identified part is required.

### DISCLOSURE

### Technical Problem

A technical problem of the present disclosure is to provide a management method for protecting personally identifiable information based on one image including a de-identified part.

The technical objects to be achieved by the present disclosure are not limited to the technical matters mentioned above, and other technical objects not mentioned are to be clearly understood by those skilled in the art from the following description.

### Technical Solution

A method for managing an image according to an aspect of the present disclosure may include determining a de-identification target among all regions in an image; performing de-identification processing for the de-identification target; and storing an image file including both data corresponding to an original image of the de-identification target and data corresponding to a de-identified image.

A device for managing a device according to an additional aspect of the present disclosure includes a transceiver; a memory; a user interface; and a processor, and the processor, based on original image data loaded from the memory, may be configured to determine a de-identification target among all regions in an image; perform de-identification processing for the de-identification target; and store an image file including both data corresponding to an original image of the de-identification target and data corresponding to a de-identified image in the memory.

It is to be understood that the foregoing summarized features are exemplary aspects of the following detailed description of the present disclosure and are not intended to limit the scope of the present disclosure.

### Technical Effects

According to the present disclosure, a management method for protecting personally identifiable information based on one image including a de-identified part may be provided.

The advantageous effects of the present disclosure are not limited to the foregoing descriptions, and additional effects will become apparent to those having ordinary skill in the pertinent art to the present disclosure based upon the following descriptions.

### DESCRIPTION OF DIAGRAMS

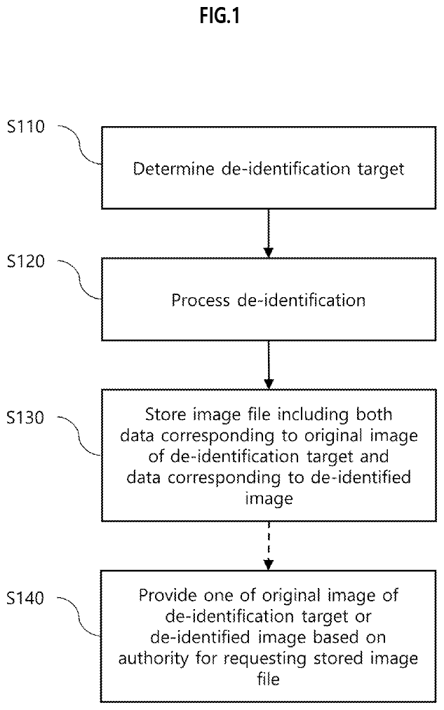

FIG. 1 is a flowchart showing an image management method according to the present disclosure.

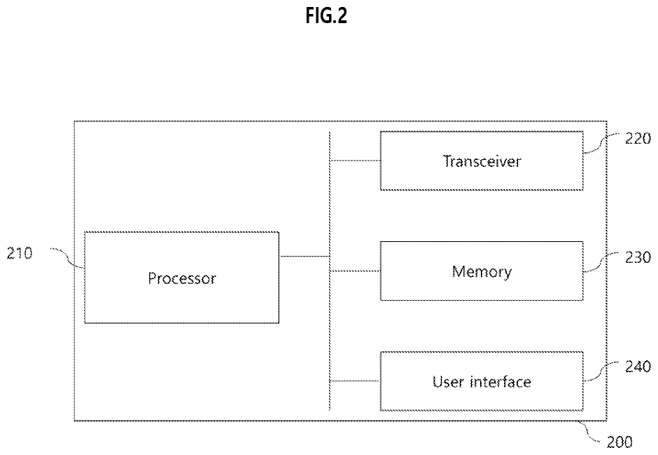

FIG. 2 is a block diagram conceptually showing a configuration of an image management device according to the present disclosure.

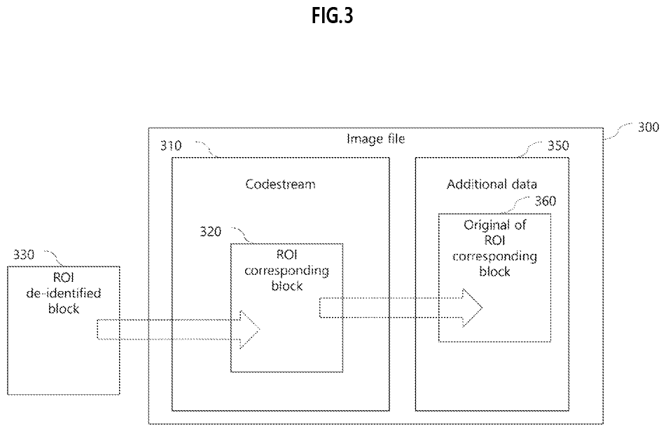

FIG. 3 is a diagram showing an illustrative structure of an image file according to the present disclosure.

### MODE FOR INVENTION

Hereinafter, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “coupled”, or “accessed” to another element, it is understood to include not only a direct connection relationship but also an indirect connection relationship. Also, when an element is referred to as “containing” or “having” another element, it means not only excluding another element but also further including another element.

In the present disclosure, the terms “first”, “second”, and so on are used only for the purpose of distinguishing one element from another, and do not limit the order or importance of the elements unless specifically mentioned. Thus, within the scope of this disclosure, the first component in one embodiment may be referred to as a second component in another embodiment, and similarly a second component in one embodiment may be referred to as a second component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in one embodiment are also included within the scope of this disclosure. Also, embodiments that include other components in addition to the components described in the various embodiments are also included in the scope of the present disclosure.

The definitions of the terms used in the present disclosure are as follows.

De-identification process means an action that, by processing a part or all of personal information, prevents a specific individual from being identified easily even when combined with other information. De-identification process according to the present disclosure includes various schemes, for example, deleting or replacing a part or all of personal information through data value deletion, pseudonymization, totalization, categorization, data masking, or the like, applying a privacy protection model, or the like. However, the scope of the present disclosure is not limited by the schemes or techniques of de-identification process.

ROI (Region of Interest) means a region of interest in an image and in the present disclosure, it may correspond to a region including a protection target in an image (e.g., a part corresponding to personally identifiable information).

A codestream means a part where actual image data/contents excluding additional data in an image file are stored. According to an image format, a codestream may be configured with at least one data block. For example, an image file may include a codestream part and a metadata part.

A marker may mean identification information on a block (or a data block) in an image. For example, an image file in a Joint Photographic Experts Group (JPEG) format may include a plurality of blocks and a marker may be defined as identification information which distinguishes each block from other blocks. For example, a marker may be defined as 2-byte data starting with 0xFF. A marker may be configured with a marker alone and it may be configured in a form including a marker and additional data.

FIG. 1 is a flowchart representing an image management method according to the present disclosure.

In S110, an image management device may determine a de-identification target among all regions in an image.

In S120, an image management device may perform de-identification processing for a de-identification target.

In S130, an image management device may store an image file including both data corresponding to an original image of a de-identification target and data corresponding to a de-identified image.

For example, data corresponding to an original image of a de-identification target may be replaced by data corresponding to a de-identified image among codestreams in an image file. In addition, data corresponding to an original image of a de-identification target may be stored in a region other than a codestream. A specific marker may be associated with data corresponding to an original image of this de-identification target.

Additionally, at least one of data corresponding to an original image of a de-identification target or data corresponding to a de-identified image may be encoded.

In S140, an image management device may provide one of a de-identified image or an original image of a de-identification target based on an authority of a request for a stored image file.

For example, in response to a request based on a first authority (i.e., having an access authority to the original or a special authority), image data that data corresponding to a de-identified image among codestreams in a stored image file is replaced by data corresponding to an original image of a de-identification target may be provided. It may be performed based on a marker associated with an original image of a de-identification target. Accordingly, an original image may be expressed.

For example, in response to a request based on a second authority (i.e., no access authority to the original or a general authority), image data including data corresponding to a de-identified image among codestreams in a stored image file may be provided. In other words, a de-identified image may be expressed.

FIG. 2 is a block diagram conceptually showing a configuration of an image management device according to the present disclosure.

A device 200 may include a processor 210, a transceiver 220, a memory 230, and a user interface 240. The processor 210, the transceiver 220, the memory 230, and the user interface 240 may exchange data, requests, responses, commands, or the like through an internal communication network.

The processor 210 may control operations of the transceiver 220, the memory 230, and the user interface 240. The processor 210 may perform operations according to the present disclosure. In addition, the processor 210 may control the overall operation of the device 200 including components of the de-identification device 200 not shown in FIG. 2.

The transceiver 220 may perform a function of a physical layer that exchanges data with other entities through wired or wireless communication.

The memory 230 may store information generated or processed by the processor 210, software, operating system, application related to the operation of the device 200, or the like, and may include components such as a buffer. In addition, the memory 230 may store data, or the like according to the present disclosure. In addition, the memory 230 may include a storage (e.g., a hard disk, etc.) for temporarily storing or maintaining data.

The user interface 240 may detect operations, inputs, or the like of a user for the device 200 and transport it to the processor 210, or may output the processing result of the processor 210 in a way that the user may recognize.

A processor 210 may be configured to perform an operation corresponding to each step of FIG. 1 or may include a module which performs each step of FIG. 1.

Hereinafter, specific examples of the present disclosure are described.

A part where personally identifiable information in an image is processed and an original part are stored in one image file and a general image output program provides a result of processing personally identifiable information. A user who needs access to an original image obtains permission of use through a management system and receives and uses an image output program which may access an original part.

Through this, an image provider may maintain an image including personally identifiable information as one file and a user who obtains permission may be guaranteed access to original data by using a separate image output program.

The present disclosure has an effect of fundamentally blocking access to an original image of a general user by storing and distributing both a de-identified part and an original part of personally identifiable information in an image in one image file and providing a separate image processing system to a user who may access an original part.

To this end, it is configured with a step of de-identifying personally identifiable information including a face, etc. among images in big data through replacement, blurring, etc., a step of storing it as one image in a single format, a step in which an image consumer obtains permission by applying for access to original data and a step of confirming an original image through a separate image output system.

FIG. 3 is a diagram showing an illustrative structure of an image file according to the present disclosure.

It may be assumed that an image file 300 of FIG. 3 is loaded from a file store. In other words, de-identification processing according to the present disclosure may be applied to an existing image.

De-identification-based image encoding according to the present disclosure may be performed for an image file 300 as follows. A region of interest (ROI) may be designated for some of images expressed (e.g., recognized by a user) by image data (e.g., a codestream 310) included in an image file 300. This ROI may correspond to a part (e.g., at least one block) of image data (e.g., a codestream). It is referred to as a ROI corresponding block 320 . In the present disclosure, for clarity of a description, one block corresponding to a ROI is described by giving an example, but a scope of the present disclosure may be also applied to a plurality of blocks corresponding to a ROI. Furthermore, a scope of the present disclosure includes not only a case in which a ROI is part of an image, but also a case in which a ROI is the entire image.

A ROI de-identification image may be determined for a ROI of an image expressed. A ROI de-identification image may include an image replacing a ROI, an image obtained by blurring a ROI, an image obtained by masking a ROI, etc.

Accordingly, a ROI de-identified block 330 corresponding to a de-identification image may be determined or generated. A ROI corresponding block 320 may be replaced or overwritten by a ROI de-identified block 330 .

Original data of a ROI correspondence block 320 corresponds to an original image of a ROI of an image expressed. The original 360 of a ROI corresponding block may be stored in an additional data 350 region in an image file 300 . An additional data 350 region is just an example, and the original 360 of a ROI corresponding block may be stored in any data block distinguished from a ROI corresponding block 320 in an image file 300. In other words, a position where the original 360 of a ROI corresponding block is stored may be any region other than a codestream 310, i.e., a region where data not used for actual image expression is stored.

If necessary, original data of a ROI corresponding block 320 may or may not be encoded selectively. When original data is encoded, access to original data is allowed only by a user/a decoder having an authority for encoding, so security performance for an original image may be improved. Additionally or alternatively, a ROI de-identified block 330 may be also encoded or not. Additionally or alternatively, encoding may or may not be applied to an image file to which de-identification is applied.

Accordingly, an original image of a ROI part may be stored in a separate data block and an image which will replace the original may be stored in an original codestream. For an image file encoded/modified in this way, metadata contents may be revised according to a format of an image file, if necessary.

As such, when an image file to which de-identification encoding is applied is decoded, image decoding may be performed by a different method according to a type of an image decoder performing decoding or a user's authority.

For example, for a user with an authority (or an image decoder type with an authority), after loading an image file (i.e., an image file to which de-identification-based encoding according to the present disclosure is applied) from a file store, based on metadata for a ROI corresponding block, a result may be provided to a user/a decoder by replacing a ROI corresponding block (or a ROI de-identified block) with a designated data block (i.e., an original data block).

For example, for a user without an authority (or an image decoder type without an authority), after loading an image file (i.e., an image file to which de-identification-based encoding according to the present disclosure is applied) from a file store, an image to which de-identification processing is applied may be expressed by expressing an image without replacing a ROI corresponding block (i.e., a ROI de-identified block as it is). Accordingly, access to an original image may be blocked for a user/a decoder without an authority.

Hereinafter, an example in which a de-identification-based image processing/management operation according to the present disclosure is applied to an image in a JPEG format is described. A scope of the present disclosure is not limited to a JPEG-like image file format, and it may be applied to any image file format having a structure corresponding to a codestream and an additional data region.

The original of a ROI corresponding block in a JPEG file may be separately stored through a JPEG Universal metadata box format (JUMBF)-Box. A JUMBF-Box is an example of a format for storing additional metadata in a JPEG standard. The original of a ROI corresponding block stored through a JUMBF-Box may be delivered to a JPEG-XT component. A JPEG-XT is an example of a format which supports an extended function of a JPEG such as a high dynamic range (HDR), a deep depth, etc. In a JPEG-XT component, a JUMBF-Box (i.e., an original image) may be encoded to be associated with a specific marker (e.g., Appll marker). In other words, metadata may be configured so that a user having an authority can access an original image through a specific marker (i.e., replace/change a ROI corresponding block/a de-identified block with an original ROI).

Meanwhile, a ROI de-identified block which will replace the original of a ROI corresponding block may be stored in a position of a ROI corresponding block in a codestream.

A result encoded in this way may be delivered to a JPEG-1 component. A JPEG-1 component corresponds to an example of an element configuring an image file included in a JPEG standard. A JPEG-1 component may be compressed in a JPEG format and delivered to a file store.

Since a user/a decoder without an authority loads a JPEG image stored in a file store and decodes an image based on a ROI de-identified block, an image to which de-identification processing is applied may be expressed.

After loading a JPEG image stored in a file store, a user/a decoder with an authority may use a specific marker (e.g., Appll marker) to acquire information on a JUMBF-Box (e.g., through a JPEG-XT component) when searching for header information in a JPEG-1 component. Accordingly, a ROI corresponding block (or a ROI de-identified block) in a codestream may be replaced/reconstructed with an original block by using the original of a ROI corresponding block stored through a JUMBF-Box. Accordingly, an image that a ROI de-identified block is replaced with an original block is decoded, so an original image to which de-identification processing is not applied may be expressed.

Although the exemplary methods of this disclosure are represented by a series of steps for clarity of explanation, they are not intended to limit the order in which the steps are performed, and if necessary, each step may be performed simultaneously or in a different order. In order to implement the method according to the present disclosure, other steps may be included to the illustrative steps additionally, exclude some steps and include remaining steps, or exclude some steps and include additional steps.

The various embodiments of the disclosure are not intended to be exhaustive of all possible combination, but rather to illustrate representative aspects of the disclosure, and the features described in the various embodiments may be applied independently or in a combination of two or more.

In addition, various embodiments of the present disclosure may be implemented by hardware, firmware, software, or a combination thereof. A case of hardware implementation may be performed by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, or the like.

The scope of the present disclosure is to encompass software or machine-executable instructions (e.g., operating system, applications, firmware, instructions, or the like) by which operations according to method of various embodiments are executed on a device or a computer, and non-transitory computer-readable media executable on the device or the computer, on which such software or instructions are stored.

1. A method of managing an image, the method comprising:
determining a de-identification target among all regions in the image;
performing de-identification processing for the de-identification target; and
storing an image file including both data corresponding to an original image of the de-identification target and data corresponding to a de-identified image.

2. The method according to claim 1, wherein:
among codestreams in the image file, data corresponding to the original image of the de-identification target is replaced by data corresponding to the de-identified image.

3. The method according to claim 2, wherein:
data corresponding to the original image of the de-identification target is stored in the region other than the codestream.

4. The method according to claim 1, wherein:
a specific marker is associated with data corresponding to the original image of the de-identification target.

5. The method according to claim 1, wherein:
at least one of data corresponding to the original image of the de-identification target or data corresponding to the de-identified image is encoded.

6. The method according to claim 1, wherein:
based on an authority for requesting the stored image file, one of the de-identified image or the original image of the de-identification target is provided.

7. The method according to claim 6, wherein:
in response to a request based on a first authority, among codestreams in the stored image file, image data obtained by replacing data corresponding to the de-identified image with data corresponding to the original image of the de-identification target is provided.

8. The method according to claim 7, wherein:
replacement of data corresponding to the de-identified image with data corresponding to the original image of the de-identification target is based on a marker associated with the original image of the de-identification target.

9. The method according to claim 6, wherein:
in response to a request based on a second authority, among codestreams in the stored image file, image data including data corresponding to the de-identified image is provided.

10. A device of managing an image, the device comprising:
a transceiver;
a memory;
a user interface; and
a processor,
wherein the processor is configured to:
based on original image data loaded from the memory, determine a de-identification target among all regions in the image;
perform de-identification processing for the de-identification target; and
store an image file including both data corresponding to an original image of the de-identification target and data corresponding to a de-identified image in the memory.

11. A computer-readable storing medium storing a computer program for executing a method at a computer according to claim 1.
